(19) United States
(12) Patent Application Publication
(10) Pub. No.: US 2020/0256327 A1
(43) Pub. Date: Aug. 13, 2020

(54) ELECTRIC FLUID PUMPING SYSTEM

(71) Applicant: Applied Cryo Technologies, Inc., Houston, TX (US)

(72) Inventors: Adam G. Van de Mortel, Webster, TX (US); Randy L. Black, Baytown, TX (US); Jack A. Smith, Crosby, TX (US)

(73) Assignee: Applied Cryo Technologies, Inc., Houston, TX (US)

(21) Appl. No.: 16/788,050

(22) Filed: Feb. 11, 2020

Related U.S. Application Data
(60) Provisional application No. 62/803,982, filed on Feb. 11, 2019.

(51) Int. Cl. F04B 17/03; F04B 15/08; F17C 9/04

(52) U.S. Cl. CPC F04B 17/03; F04B 15/08; F17C 9/04; F17C 2270/0168; F17C 2227/0304; F17C 2227/0327; F17C 2221/014; F04B 2015/0824

(57) ABSTRACT

A fluid pumping system may include an engine, an electric generator, an electrically driven pump, and a first electrical resistance heating element. The engine may drive the generator, and the generator may supply power to the electrically driven pump and the electrical resistance heating element. The first electrical resistance heating element may be positioned to apply heat to fluid pumped by the electrically driven pump.

### CROSS-REFERENCE TO RELATED APPLICATIONS

This applications claims the benefit of priority of U.S. Provisional Patent Application No. 62/803,982 to Adam Van de Mortel et al. filed on Feb. 11, 2019, and entitled “Electric Nitrogen Pumper,” which is hereby incorporated by reference in its entirety.

### FIELD OF THE DISCLOSURE

The instant disclosure relates to fluid pumping systems. More specifically, portions of this disclosure relate to fluid pumping systems with electric heating elements.

### BACKGROUND

Chemical fluids, such as cryogenic fluids like nitrogen, are used in a variety of industrial applications. Such fluids may be transported to industrial sites, such as manufacturing sites, refining sites, power generation sites, mining sites, drilling sites, and other industrial sites. In some applications, fluids, such as nitrogen, may be transported at a low temperature and/or high pressure, in liquid form, and may be heated and vaporized when ready for use.

Fluids may be chilled to a low temperature and placed in a pressurized fluid tank, such as a cryogenic tank, for efficient transportation in liquid form. The transported fluids may often require an increase in temperature and/or pressure for use in industrial applications. Thus, the fluids may be heated as they are pumped out of a fluid tank. An example system 100 for heating fluids as they are pumped from a fluid tank 102 is shown in FIG. 1. A fluid tank 102 may contain pressurized and/or cooled fluids. The fluids may be cryogenic fluids, such as nitrogen. A pump 104, in fluid communication with the tank 102, may increase the pressure and flow rate of the fluids from the tank 102. The pump 104 may, for example, be driven by a mechanical or hydraulic drive 110. The mechanical or hydraulic drive 110, in turn, may be driven by a fuel burning engine 108, such as a diesel engine. For example, the pump 104 and drive 110 may convert some or all of the rotational shaft power from the engine 108 to rotational shaft power at the pump 104. The pump 104 may be a cryogenic pump. The pump 104 may pump fluid from the fluid tank 102 through a fired heat exchanger 106 to heat the fluid, further raising a pressure of the fluid, in some cases to pressures greater than or equal to 10,000 pounds per square inch (psi), and prepare a heated pressurized gas for use. For example, the fired heat exchanger 106 may apply sufficient heat to the fluid pumped by the pump 104 to vaporize the fluid. The fired heat exchanger 106 may burn a fuel source, such as diesel, to provide direct heating to the fluid. A fired heat exchanger may be lightweight, and may be transported on a vehicle 200, as shown in FIG. 2. For example, a cab 208 may pull a trailer holding a fluid tank 202, a pump 204, and a diesel engine 206 to transmit a liquid pumping system to a location for use. A pumping apparatus including a pump 204, a tank 202, and a diesel engine 206 may be mounted on a truck chassis, trailer, or movable skid. A fired heat exchanger 209 may also be mounted on the chassis, trailer, or movable skid. Fired heat exchangers may also allow for high fluid pump rates, such as a conversion rate of over 500,000 standard cubic feet per hour (SCFH) of cryogenic liquid nitrogen to a warm pressurized nitrogen gas stream in nitrogen pumping applications.

Fired heaters, while allowing high heat production, can be wasteful, high maintenance, and hazardous. For example, the open flames used by fired heat exchangers can increase the risk of industrial events and injury. Fired heat exchangers may be unsuitable for use at refining, drilling, and chemical processing sites. In many applications, fired heat exchangers may increase safety concerns and may pose unique risks when site conditions change unexpectedly or when such heaters are implemented in hazardous rated areas. Furthermore, fired heat exchangers can waste significant amounts of energy, due to heat loss to the atmosphere. Fired heat exchangers can also require substantial maintenance and frequent troubleshooting.

Shortcomings mentioned here are only representative and are included simply to highlight that a need exists for improved liquid pumping systems. Embodiments described herein address certain shortcomings but not necessarily each and every one described here or known in the art. Furthermore, embodiments described herein may present other benefits than, and be used in other applications than, those of the shortcomings described above.

### SUMMARY

Fluid pumping systems, such as cryogenic fluid pumping systems, may incorporate electrically driven pumps and heaters to enhance efficiency, productivity, and safety, and to reduce costs. For example, a fluid pumping system may include an electric generator coupled to an engine, such as a diesel engine, to generate electrical power to power the system. The electric generator may power an electrically driven pump to pump fluid from a fluid tank and through a piping system. The fluid pumped by the electrically driven pump may be heated by one or more electric heaters, such as electrical resistance heating elements, also powered by the electric generator. If additional heat is needed, the fluid may also be heated by heat recovery units, placed to transfer heat generated by the engine to the fluid. The use of an electrically driven pump and electric heater may enhance the efficiency of the system over use of hydraulic or mechanical pumps and fired heat exchangers. For example, a greater percentage of heat generated by electric heaters may be captured and transferred to the pumped fluid than heat generated by fired heat exchangers. A substantial percentage of heat generated by fired heat exchangers may be transferred to the surrounding environment and lost. Use of electric heaters to heat fluid pumped by the electrically driven pump may also reduce or eliminate the safety risks associated with fired heat exchangers. For example, electric heaters do not require an open flame for heat generation and thus the risks associated with maintaining an open flame at an industrial site may be reduced or eliminated. Furthermore, use of electric heaters, such as those including electrical resistance heating elements, may reduce maintenance costs of equipment, as resistive heating elements may be significantly less prone to equipment failure and may require substantially less regular maintenance than fired heat exchangers. Thus, an electrically driven pump and electrical resistance heating elements may be used in a fluid pumping system to enhance the safety, efficiency, and cost effectiveness of fluid pumping systems over the use of fired heat exchangers.

A fluid pumping system may include an engine, such as a diesel engine. The engine may drive an electric generator for providing power to the fluid pumping system. The electric generator may power an electrically driven pump for pumping fluid through the fluid pumping system. The electrically driven pump may pump fluid from a fluid tank through a fluid piping system to an outlet. For example, an output of the electrically driven pump may be coupled to a pipe.

The electric generator may also power one or more electrical resistance heating elements. The electrical resistance heating elements may be positioned to heat fluid being pumped by the electrically driven pump. The electrical resistance heating elements may be coupled to a pipe, for example a pipe of a fluid piping system, via heat exchangers, such as conductive heat exchangers, to transfer heat from the electrical resistance heating elements to fluid pumped through the piping system. The electrical resistance heating elements may be included in banks of electrical resistance heating elements to provide variable heating to fluid pumped through the piping system. For example, a first electrical resistance heating element may be included in a first bank of electrical resistance heating elements, while additional electrical resistance heating elements may be included in additional banks of electrical resistance heating elements. The banks of electrical resistance heating elements may be activated or controlled individually, to allow for customizable heating of fluid pumped through the piping system. For example, when fluid is pumped through a pipe at a higher rate, additional heat may be required to raise the fluid to a desired temperature. In such a situation, additional electrical resistance heating elements may be activated or controlled to provide additional heat. Thus, in some embodiments, cryogenic fluid, such as nitrogen, pumped from a fluid tank in liquid form may be heated by the electrical resistance heating elements and converted to a heated gas state.

Heat generated by the engine driving the electric generator, and by other components of the fluid piping system, may be captured and used to further heat fluid pumped by the electrically driven pump. For example, one or more heat recovery units may be located to transfer heat generated by the engine to fluid pumped by the electrically driven pump. Heat recovery units may include engine coolant heat recovery units, radiant heat recovery units, charge air heat recovery units, engine oil heat recovery units, and engine exhaust heat recovery units. A single heat recovery unit may recover heat from multiple sources and may apply the recovered heat to fluid in the pipeline. A heat recovery unit may include heat exchangers coupled to the piping system of the fluid pumping system, such as to a pipe of the fluid pumping system, to transfer heat to the fluid. The heat exchanger may, for example, be a convective heat exchanger. For example, convective heat exchangers may transfer heat from a heat source to a secondary fluid pipeline, such as a coolant pipeline. Heat may then be transferred from the secondary coolant pipeline to a main pipeline of fluid pumped by the fluid pumping system. The heat exchanger of the heat recovery unit may be coupled to the pipe further from the outlet of the electrically driven pump than the heat exchangers coupled to the electrical resistance heating elements. Thus, the fluid may be heated by one or more electrical resistance heating elements before it is heated by the heat recovery units.

In some embodiments, a bypass pipeline may be included to bypass one or more heat recovery units and/or one or more electrical resistance heating elements. For example, a flow path of the fluid may be directed through a portion of the pipe heated by one or more electrical resistance heating elements, but may be bypassed through a bypass pipe around a portion of the pipe heated by one or more heat recovery units. In some embodiments, the fluid pumping system may include a controller configured to route the fluid through the bypass pipeline or close off the bypass pipeline based, at least in part, on a desired temperature of the fluid. For example, if the electrical resistance heating elements alone provide sufficient heating to raise a temperature of the fluid to a desired temperature, the controller may route the fluid through a bypass. If, on the other hand, the fluid requires more heating than is provided by the electrical resistance heating elements to heat the fluid to a desired temperature, the controller may route the fluid through a portion of the pipe that is heated by one or more heat recovery units and may close off the bypass pipeline. Routing the fluid through the bypass pipeline by the controller may include opening a first valve of the bypass pipeline to allow fluid to flow through the bypass pipeline and closing a second valve of a main fluid piping system to prevent fluid from flowing through a portion of the main fluid piping system heated by one or more heat recovery units.

In some embodiments, the controller may also selectively energize and/or control current to the individual electrical resistance heating elements and/or banks of electrical resistance heating elements to provide an amount of heating required to raise a temperature of the fluid to a desired level, providing variable fluid heating. For example, the controller may determine an activation status of first and second, and, in some embodiments, more, electrical resistance heating elements based, at least in part, on a desired fluid temperature and may adjust an amount of power provided to each of the first and second, and, in some embodiments, more, electrical resistance heating elements based on the determined activation statuses. For example, determining an activation status may include determining an amount of current flowing through one or more electrical resistance heating elements or banks of electrical resistance heating elements. In some embodiments, the controller may be configured to determine activation statuses of first and second or more electrical resistance heating elements based, at least in part, on a flow rate of fluid. For example, fluid with a greater flow rate may require additional heating to raise the fluid to a desired temperature, and thus additional current may be required and/or additional electrical resistance heating elements may require activation. Electrical resistance heating elements may be assembled in banks of electrical resistance heating elements, and the controller may control activation statuses of banks of electrical resistance heating elements based, at least in part, on a desired temperature and flow rate. The controller may also be further configured to control a flow rate, pressure, and temperature of the fluid by selectively energizing and/or controlling current flow to the electrical resistance heating elements and controlling a speed of the electrically driven pump and/or a speed of the electric generator. For example, the controller may control a load on the electric generator and/or engine.

A method for heating fluid in an electric fluid pumping system may begin with generating power using an electric generator driven by an engine to power an electrically driven pump. The method may continue with pumping fluid through the piping system using the electrically driven pump powered by the electric generator. The method may further continue with heating fluid as the fluid is pumped through the piping system using one or more electrical resistance heating elements. In some embodiments, the fluid may be further heated as it is pumped through the piping system after being heated by the electrical resistance heating elements using one or more heat recovery units that are configured to transfer heat generated by the engine to the fluid pumped by the electrically driven pump. A controller may control a flow of the fluid to bypass at least one of the electrical resistance heating elements and the heat recovery unit based on a desired fluid temperature. In some embodiments, multiple electrical resistance heating elements may be used to heat the fluid, and a controller may be used to deactivate and/or control current flow to one or more electrical resistance heating elements based on a desired fluid temperature.

An apparatus may include a controller, such as a controller with a memory and a processor, for performing the steps described herein. Instructions for performing the steps described herein may be stored on a non-transitory computer readable medium.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a diagram of an example fluid pumping system with a fired heat exchanger, according to the prior art.

FIG. 2 is a perspective illustration of an example mobile fluid pumping system with a fired heat exchanger, according to the prior art.

FIG. 3 is a diagram of an example electric fluid pump drive system according to some embodiments of the disclosure.

FIG. 4A is a block diagram of an example electric fluid pumping system with multiple electrical resistance heating elements according to some embodiments of the disclosure.

FIG. 4B is a block diagram of an example electric fluid pumping system with multiple electrical resistance heating elements and a combined heat recovery unit according to some embodiments of the disclosure.

FIG. 5 is a block diagram of an example electric fluid pumping system with an electrical resistance heating element array controlled by one or more power control devices, such as mechanical contactors closed by electromechanical relays (EMR), or Solid State Relays (SSR) with Silicon-Controlled Rectifiers (SCR), according to some embodiments of the disclosure.

FIG. 6 is a diagram of an example coolant heat recovery unit according to some embodiments of the disclosure.

FIG. 7 is a flow chart of an example method for heating fluid using one or more electrical resistance heating elements according to some embodiments of the disclosure.

FIG. 8 is a flow chart of an example method of determining a flow route for fluid in an electrically driven fluid pumping system according to some embodiments of the disclosure.

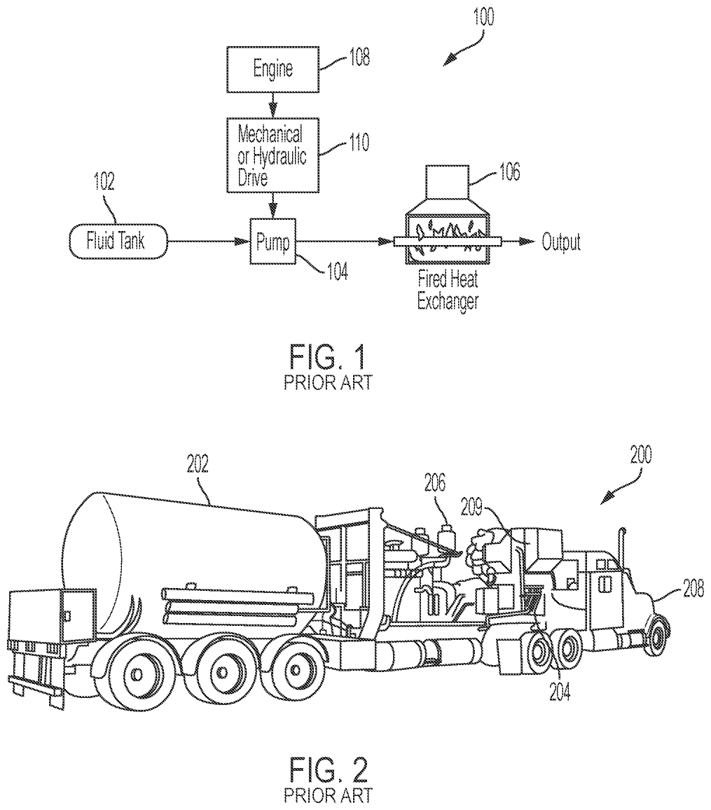

### DETAILED DESCRIPTION

Fluids are used in a variety of industrial applications. Many fluids used in industrial applications are be transported to industrial sites for use. Some fluids, such as cryogenic fluids, are transported in liquid form, at low temperatures and high pressure. In some cases, such fluids require heating to raise a temperature of the fluid and/or transition the fluid from a liquid to a gaseous state for use. Fluid storage and pumping equipment may be transported to industrial sites via vehicles designed to tow fluid processing and other equipment. It may be advantageous for fluid processing equipment to meet certain size and weight restrictions, while still providing a high pumping capacity. An electrical fluid pumping system may provide enhanced portability, safety, cost-effectiveness, and efficiency over systems that incorporate fired heat exchangers.

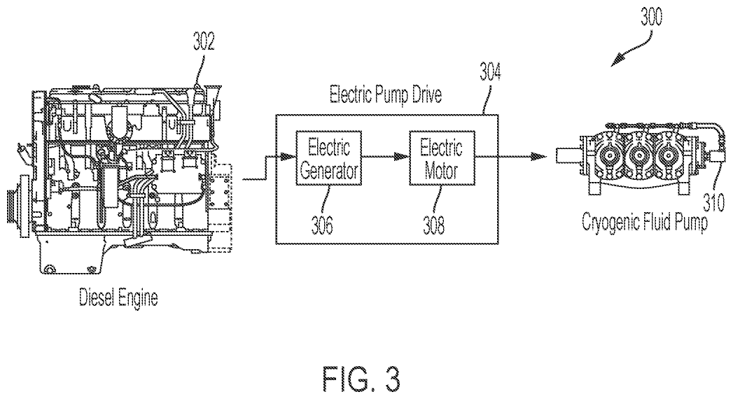

An electric fluid pumping system may incorporate an electrically driven fluid pump to enhance reliability and efficiency. An example pump drive system 300 is shown in FIG. 3. An engine 302, such as a diesel engine, may drive an electric pump drive 304, that may in turn provide power to and drive a fluid pump 310, such as a cryogenic fluid pump. The electric pump drive may, for example, include an electric generator 306, driven by the engine 302, which may generate electricity used to power an electric motor 308. The electric motor 308 may drive the fluid pump 310 to pump fluids, such as cryogenic fluids like nitrogen. Electric pump drives may provide advantages over hydraulic pump drives, including hydraulic pumps and motors, and mechanical drives, such as transmissions allowing engines to drive fluid pumps, used in systems including fired heat exchangers. The advantages provided by use of an electric pump drive may include increased efficiency, enhanced reliability, and enhanced safety. In some cases, hydraulic pumps and motors and mechanical drives may be used in systems that do not include fired heat exchangers, but instead rely solely on recovering heat generated by an engine and a drive to heat fluid. Hydraulic pumps and motors and mechanical drives may also be used in systems that incorporate hydraulic shear systems, water brakes, or other friction processes to forcefully produce heating by loading the engine. Such flameless heat recovery systems may have low maximum flow rates, may be prohibitively heavy, high maintenance, hazardous, and/or may be inefficient and expensive. Thus, a system having no hydraulic or mechanical pump drives and capable of providing heat through alternative means may be preferable for some applications.

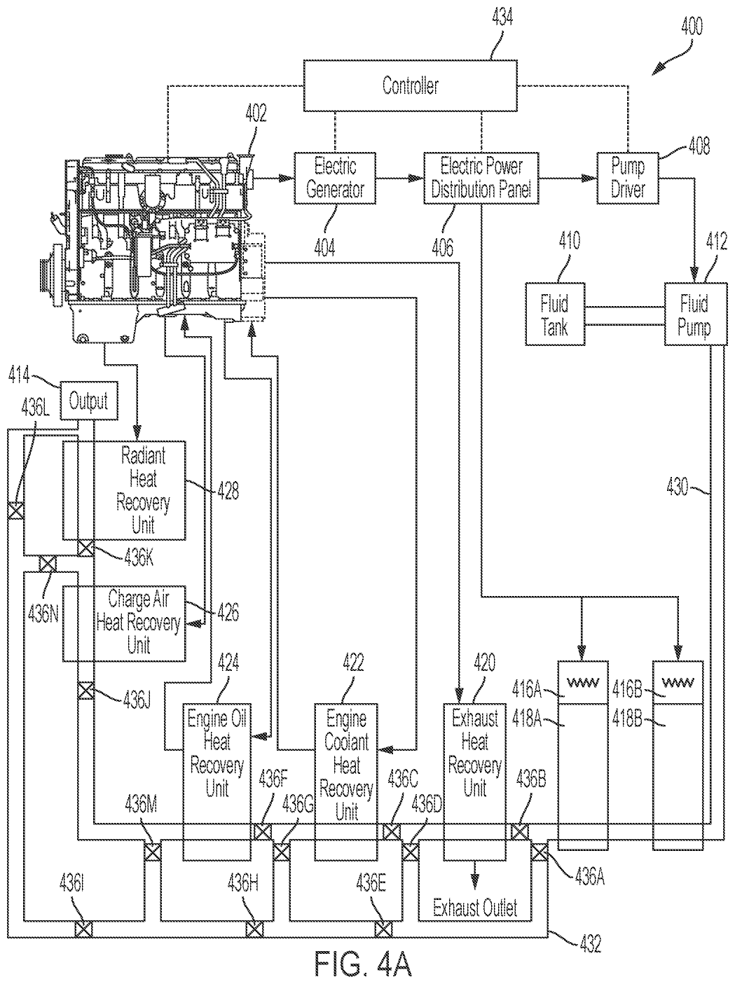

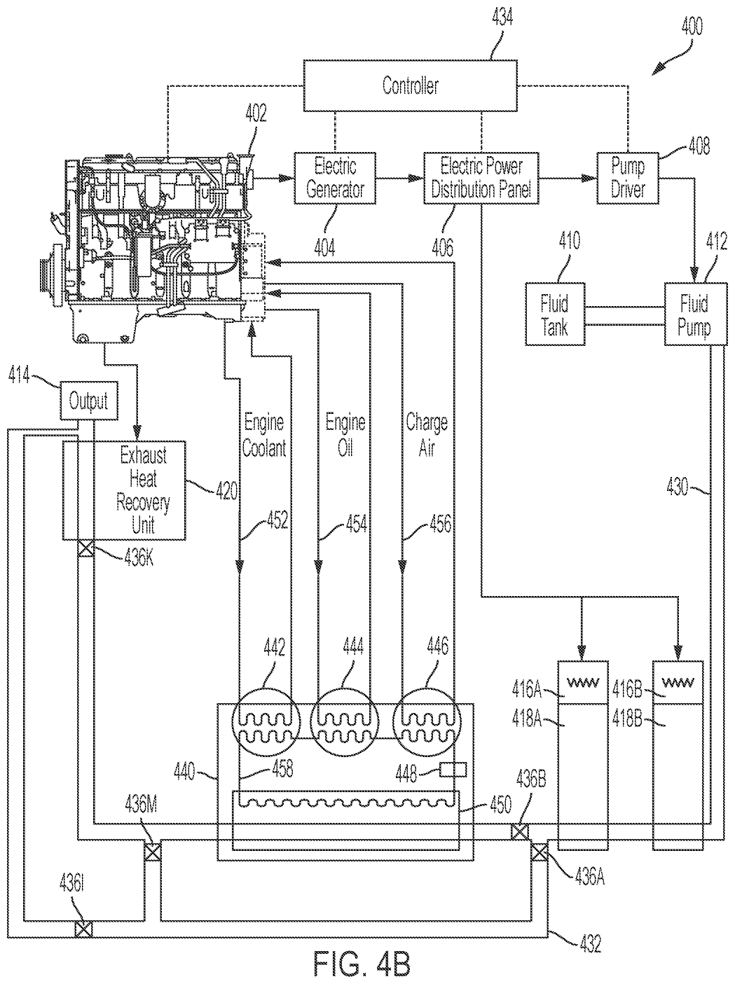

An electric generator or plurality of electric generators in an electric fluid pumping system may be used to power one or more electric motors and one or more electrical resistance heating elements, providing efficient, safe, and high capacity, fluid pumping and heating. An example electric fluid pumping system 400 is shown in FIG. 4A. An engine 402, such as a diesel engine may drive an electric generator 404. In some embodiments, multiple engines may drive multiple electric generators. The engine 402 may be selected to meet performance, emissions, weight, and space requirements for an optimized and portable configuration. The electric generator 404 may load the engine 402, causing the engine 402 to produce heat. The electric generator 404 may generate electricity to power the fluid pumping system 400. An electric power distribution panel 406 may receive the power output by the electrical generator and may pass the power to one or more components of the fluid pumping system 400. The electric power distribution panel 406 may, for example, include one or more power control devices, such as mechanical contractors closed by electromechanical relays (EMR) or Solid State Relays (SSR) incorporating Silicon-Controlled Rectifiers (SCR) as the output device instead of mechanical contacts to switch the controlled power, for connecting power output by the electric generator 404 to one or more components of the fluid pumping system 400. For example, the electric power distribution panel may provide power to an electric pump driver 408. The electric pump driver 408 may drive the fluid pump 412 to pump fluid through the electrically driven fluid pumping system 400. In some embodiments, the electric generator 404 may power multiple electric pump drivers for multiple electrically driven pumps. The fluid pump 412 may pump fluid from the fluid tank 410 through the system 400. For example, the fluid pump 412 may pump fluid from the fluid tank 410, through the pipeline 430 to the output 414. The fluid may for example, be a cryogenic fluid, such as liquid nitrogen. The fluid pump 412 and the pump driver 408 may be selected to meet performance, weight, and space utilization standards required for an efficient portable pumping system.

The fluid may be pumped through portions of the pipeline 430 heated by a variety of heat sources. For example, the electric power distribution panel 406 may provide power from the electric generator 404 to a first electrical resistance heating element circuit 416A and a second electrical resistance heating element circuit 416B. Heat exchanger sections 418A and 418B may be coupled in proximity with the first electrical resistance heating element circuit 416A and the second electrical resistance heating element circuit 416B to transfer heat from the electrical resistance heating element circuits 416A, B to fluid pumped through the pipeline 430. In some embodiments, the heat exchanger sections 418A-B may be conductive heat exchangers and may be coupled directly between the electrical resistance heating element circuits 416A-B and the pipeline 430. The heat exchangers 418A-B may, for example, be comprised of a solid medium between the electrical resistance heating element circuits 416A-B and the pipeline 430. Thus, the electric generator 404 may power electrical resistance heating element circuits 416A-B to raise a temperature of fluid pumped through the pipeline 430. In some embodiments, multiple electrical resistance heating elements may be included in electrical resistance heating element banks for providing adjustable heating to fluid pumped through the pipeline 430. The electrical resistance heating element circuits 416A-B may further load the generator 404 and, by extension, the engine 402, causing the engine 402 to produce additional heat, which can be recovered, in full or in part, to provide further heating to fluid pumped by the system 400. In some embodiments, a single heat exchanger may be used to transfer heat from all electrical resistance heating elements to fluid pumped by the system. In some embodiments, the electrical resistance heating element circuits 416A-B may convert close to 100% of energy received from the electric generator to heat.

In some embodiments, the cooling system may include one or more heat recovery units to recover heat produced by the system and channel the recovered heat to heat fluid pumped through the pipeline 430. The heat recovery units may be located along the pipeline 430 such that the fluid pumped through the pipeline 430 passes through portions of the pipeline heated by the electrical resistance heating elements 416A-B before it is passed through portions of the pipeline heated by the heat recovery heat exchanger units. The heat recovery units may, for example, include heat transfer units to transfer heat from the engine 402, and other components of the system 400, to fluid pumped through the pipeline. In some embodiments, the heat transfer units may transfer heat from gas or liquid to a heat transfer liquid pipeline, that may then be used to heat fluid pumped through the pipeline 430 via one or more heat exchangers coupled between a heat transfer pipeline and the pipeline 430. For example, a coolant an exhaust heat recovery unit 420 may transfer heat contained in engine exhaust to fluid pumped through the pipeline 430. The exhaust heat recovery unit 420 may, for example, include an exhaust inlet to receive exhaust from the engine and an exhaust outlet to output exhaust after heat has been transferred to the fluid. The exhaust heat recovery unit 420 may, in some cases, be positioned along the pipeline 430 closer to the output 414 than any other heat recovery units. An engine coolant heat recovery unit 422 may transfer heat from coolant, that has absorbed heat produced by the engine, to fluid pumped through the pipeline 430. In some embodiments, the engine coolant heat recovery unit 422 may include an input, for receiving heated coolant from the engine 402, and an output, for returning coolant to the engine 402 after heat has been transferred from the engine coolant to a separate coolant circuit shown in FIG. 6, or directly to the fluid being pumped. The coolant heat recovery unit 422 may recover heat from a water jacket of the engine. In some embodiments, an engine oil heat recovery unit 424 may transfer heat from oil heated by the engine to a coolant heat recovery unit, to fluid pumped through the pipeline 430. The engine oil heat recovery unit 424 may include an input for receiving heated engine oil and an output for returning cooled engine oil to the engine 402 after heat has been transferred from the engine oil to the coolant heat recovery unit and thus to the fluid pumped through the pipeline 430. In some embodiments, a charge air heat recovery unit 426 may receive charge air used by the engine 402 and may transfer heat from the charge air to the coolant heat recovery unit and thus to the fluid pumped through the pipeline 430. In some embodiments, a radiant heat recovery unit 428 may capture radiant heat produced by the engine 402 and may transfer the radiant heat to the coolant heat recovery unit and thus to the fluid pumped through the pipeline 430. Thus, one or more heat recovery units may work together with the electrical resistance heating elements 416A-B to heat fluid pumped through the pipeline 430. Heat recovery units may include plate heat exchangers, shell and tube heat exchangers, water pot vaporizers, and other heat exchangers.

In some embodiments, multiple heat recovery units may be combined in a single heat recovery unit. For example, heat from multiple engine heat sources may be used to heat a secondary coolant line, which may, in turn, be used to heat the fluid pumped through the main pipeline by the fluid pumping system. An example system in which multiple heat recovery units are combined into a single heat recovery unit is shown in FIG. 4B. For example, engine coolant 452, engine oil 454, and charge air 456 may be transferred to a combined heat recovery unit 440. Heat from the engine coolant 452, engine oil 454, and charge air 456 may, in some embodiments, be transferred to fluid pumped through the main pipeline 430 via convective heat transfer. For example, heat transfer units 442, 444, and 446 may transfer heat from the engine coolant 452, engine oil 454, and charge air 456 to coolant in a secondary cooling line 458. After heat is transferred from the engine coolant 452, the engine oil 454, and the charge air 456 to the secondary cooling line 458, the engine coolant 452, the engine oil 454, and the charge air 456 may be returned to the engine 402. In some embodiments, engine coolant 452 may be pumped through the secondary cooling line 458 and may receive heat from engine oil 454 and charge air 456. The heat transfer units 442, 444, and 446 may, for example, be plate heat exchangers. Heat from the secondary cooling line 458 may be transferred to fluid pumped through the main line 430. Thus, the secondary cooling line 452 may transfer heat from multiple engine heat sources, such as engine coolant 452, engine oil 454, and charge air 456, to fluid pumped through the main line 430 by the fluid pumping system. A pump 448 may pump coolant through the secondary cooling line 458. Heat may be transferred from the secondary cooling line 458 to fluid pumped by the fluid pumping system via a heat exchanger 450, such as a water pot heat exchanger. Thus, in some embodiments multiple heat recovery units may be combined into a single heat recovery unit, which may transfer heat from the multiple engine heat sources to a secondary coolant fluid and from the secondary coolant fluid to the fluid pumped by the fluid pumping system via convective heat transfer.

In some embodiments, an exhaust heat recovery unit 420 may be placed at the end of the pipeline 430, as shown in FIG. 4B, such that the fluid pumped through the pipeline 430 is heated by other heat sources prior to being heated by the exhaust heat recovery unit 420. The exhaust heat recovery unit 420 may include an exhaust gas heat exchanger, which may recover exhaust waste heat from the engine and use the recovered heat to heat the fluid pumped through the pipeline 430. The exhaust may, for example, have a temperature of approximately 900 degrees Fahrenheit, while the fluid pumped through the exhaust heat recovery unit 420 may have a temperature of approximately 180 degrees Fahrenheit.

A desired fluid output temperature for the fluid pumping system 400 may vary based on application and/or a type of fluid being pumped by the pumping system 400. Furthermore, the amount of heat required to heat fluid to a desired temperature may vary based on a desired output rate of the system 400. A controller 434, such as a programmable logic controller, may control a speed of the pump driver 408 and thus the demand from the electric generator 404 and may control a load on the engine 402. For example, the controller 434 may include one or more variable frequency drives used to control a speed of an electric drive, such as an electric motor, driving a pump and/or a speed of an electrical motor driving one or more heat recovery coolant pumps, such as those used in a heat recovery unit including a water pot vaporizer. The controller 434 may also control the electrical power distribution panel 406 to control power delivered to the pump driver 408 and the electrical resistance heating elements 416A-B. The controller 434 may control a speed of the pump driver 408 to control a rate at which fluid is pumped through the system. For example, the controller 434 may adjust a speed of the pump driver to match a flow rate through the pipeline 430 to a desired flow rate and/or a pressure of fluid pumped through the pipeline 430 to a desired pressure. In some embodiments, the controller 434 may control an amount of power provided to the electrical resistance heating elements 416A-B based on a desired fluid temperature. The controller 434 may determine an amount of heating needed from the electrical resistance heating elements to raise a temperature of the fluid to a desired temperature based, at least in part, on a flow rate of the fluid through the pipeline 430 and may control an amount of power delivered to the electrical resistance heating elements 416A-B to provide the required amount of heating. For example, the controller may fully activate and/or send maximum current to both heating elements 416A-B to provide a maximum amount of heating from the electrical resistance heating elements 416A-B. If less than the maximum amount of heating is required, the controller may turn off one or more of the electrical resistance heating elements 416A-B and/or reduce current flow to any of these. In some embodiments, the controller 434 may vary an amount of power provided to the electrical resistance heating elements 416A-B at a finer level by, for example, adjusting a level of voltage or current provided to the electrical resistance heating elements 416A-B beyond an on/off status. For example, more voltage may be applied or more current supplied to generate more heat, and voltage applied or current supplied may be reduced to generate less heat. In some embodiments, the electrical resistance heating elements 416A-B may be comprised in banks of electrical resistance heating elements. In such embodiments, the controller may activate and deactivate banks of electrical resistance heating elements as a unit or individual electrical resistance heating elements within the banks to provide variable control of the amount of heat applied to fluid pumped through the pipeline 430. Electrical resistance heating elements may include heating rods or cartridges and may be arranged in multiple banks of heating rods or cartridges.

The pipeline 430 may also include one or more bypasses 432 to bypass the heat recovery units based on a desired fluid temperature. For example, if the controller 434 determines that heat from the heat recovery units is not necessary to raise a temperature of the fluid pumped through the pipeline 430 to a desired temperature, the controller 434 may divert the fluid flow through one or more bypasses 432, so that the fluid does not pass through portions of the pipeline 430 that are heated by the heat recovery units 420-428. The fluid pumping system 400 may, for example, include a plurality of valves 436A-L controlled by controller 434 to control flow of fluid through the pipeline 430. As one example, if the controller determines that no heat from the heat recovery units is required to heat the fluid to the desired temperature, the controller may open valves 436A, E, H, I, and L and close valves 436B, C, D, F, G, J, K, M, and N to cause fluid to bypass all of the heat recovery units as it flows to the output 414. In some embodiments, where multiple heat recovery units are combined in a single heat recovery unit, a single bypass may bypass the combined heat recovery unit. For example, a first bypass may bypass the combined heat recovery unit while a second bypass may bypass an exhaust heat recovery unit, as shown in FIG. 4B. A controller may, for example, open valves 436A, 436M, and 436K, while closing valves 436B and 4361 to cause fluid flowing through the main pipeline 430 to be heated by the exhaust heat recovery unit 420, but not by the combined heat recovery unit 440. Thus the controller 434 may control application of heat to fluid as the fluid flows through the pipeline 430.

The weight of the pumping system 400 may be approximately 64,000-70,000 pounds to allow for transportation. The system 400 may be designed to meet space requirements of a trailer having a length of 53 feet, a width of eight feet, six inches, and a height of thirteen feet, five inches. The system 400 may further include a fuel tank for the engine 402 having a capacity of 400 gallons or more. The system 400 may have a configurable pumping rate, set by the controller 434, which may range from less than 1,500 SCFH to greater than 600,000 SCFH. The system 400 may be configurable to produce a discharge pressure for fluid pumped by the system 400 of up to, and, in some embodiments, greater than, 10,000 psi. The system 400 may be further designed to operate with discharge fluid temperatures ranging from less than −320 degrees Fahrenheit to greater than 850 degrees Fahrenheit.

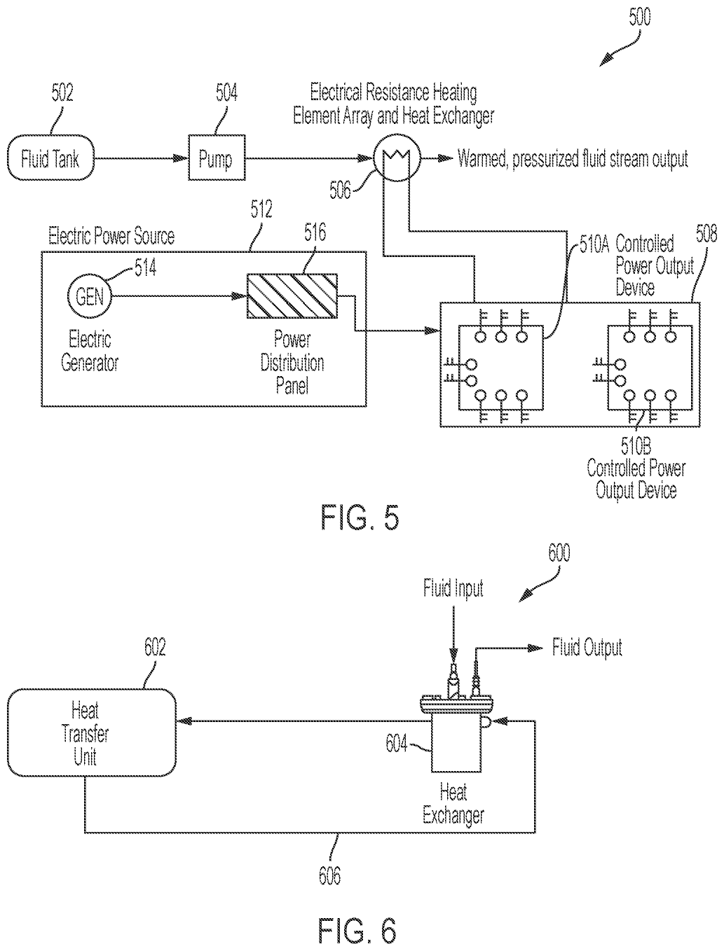

EMR controlled mechanical contactors or SSR controlled SCRs may be used to control an activation status of the electrical resistance heating elements. An example diagram of a fluid pumping system 500 including contactors, SCRs, or other controlled power output devices for controlling power applied to banks of electrical resistance heating elements in an array, is shown in FIG. 5. Fluid may be pumped, by a pump 504, from a fluid tank 502 through a combined heat exchanger and electrical resistance heating element array 506 to an output. The fluid stored in the tank may be a compressed cryogenic liquid, stored at a cold temperature, while the fluid output from the system 500 after heating may be a warm, pressurized fluid stream. The electrical resistance heating element array 506 may be powered by an electrical power source 512. The electrical power source 512 may include an electrical generator 514 and a power distribution panel 516. The power distribution panel may control distribution of power to the system. An electrical enclosure 508 may include EMR controlled mechanical contactors, SSR controlled SCRs, or other controlled power output devices for controlling an activation status of the electrical resistance heating element banks in the array 506. For example, a first controlled power output device 510A, such as an EMR controlled mechanical contactor, SSR controlled SCR, or other controlled power output device, may connect a first circuit of the electrical resistance heating element array 506 to the power distribution panel 516. A second controlled power output device 510B may connect a second circuit of the electrical resistance heating element array 506 to the power distribution panel 516. In some embodiments, controlling an activation status of one or more electrical resistance heating elements using controlled power output devices 510A-B may include adjusting a level of current provided to one or more electrical resistance heating elements to adjust an activation level of the one or more electrical resistance heating elements, such as an amount of heat provided by the one or more electrical resistance heating elements. A controller may control the status of the controlled power output devices 510A-B to control an activation status of the electrical resistance heating element banks in the array 506. For example, when both contactors 510A-B are closed, current may be allowed to flow through all the electrical resistance heating element banks in the array 506, thereby generating high heat. When at least one of the contactors 510A-B is open, less current may flow through the electrical resistance heating element array 506, and one or more banks in the electrical resistance heating element array 506 may be turned off. In some embodiments, electrical resistance heating elements may be in the form of heating rods or cartridges, and banks of electrical resistance heating elements may be in the form of banks of heating rods or cartridges that are bussed together. In such embodiments, an individual contactor, SCR, or other controlled power output device may be connected to energize a bank of heating rods or cartridges. Multiple contactors, SCRs, or other controlled power output devices may be used to energize multiple banks of heating rods or cartridges. Thus, a bank of multiple electrical resistance heating elements may be activated by closing a single contactor and deactivated by opening the contactor. In some embodiments, current flow to a bank of electrical resistance heating elements may be more precisely controlled using one or more SCRs or other controlled power output devices to adjust current flow to the bank of electrical resistance heating elements.

Heat transfer units may be used in heat recovery units to transfer heat from a heat source to coolant pumped through a heat recovery pipeline. Heat may then be transferred from the fluid of the heat recovery pipeline to the fluid pumped through the main pipeline of the electrically driven fluid pumping system. An example heat recovery unit 600 is shown in FIG. 6. A heat transfer unit 602 may receive a heat source from the engine. For example, heated coolant from an engine may be received by the heat transfer unit 602. The heat received from the heat transfer unit may be used to heat coolant in a closed loop coolant circuit 606. The coolant in the closed loop coolant circuit may be pumped through the closed loop to the heat transfer unit 602 to reheat the coolant after the heat has been transferred to fluid pumped through a pipeline of the electrically driven fluid pumping system. For example, the coolant may be pumped through a heat exchanger 604, such as a water pot heat exchanger. The heat exchanger 604 may include an input for receiving fluid from the pipeline of the system and an output for outputting heated fluid to the remaining portion of the pipeline. In some embodiments, the coolant may be pumped through the closed loop 606 by an electrically driven coolant pump. The coolant from the closed loop 606 may pass through the heat exchanger 604 and may pass its heat to the fluid of the main pipeline. In some embodiments, the closed loop 606 may collect heat from multiple engine heat sources, such as through heat transfer units transferring radiant heat, exhaust heat, charge air heat, and engine oil heat, to the closed loop coolant line 606. A single heat recovery unit 600 may collect heat from multiple engine, and other equipment, heat sources and may transfer the heat to fluid pumped by the fluid pumping system using one or more heat exchangers 604, such as a water pot vaporizer. Thus, the heat recovery unit may use a heat transfer unit and closed loop coolant circuit to transfer heat generated by the engine to fluid pumped through the pipeline. In some embodiments, an engine coolant line may be used to collect heat from other engine heat sources, such as engine oil, exhaust, charge air, and other engine heat sources and may transfer heat to the main pipeline via a heat exchanger, such as heat exchanger 104.

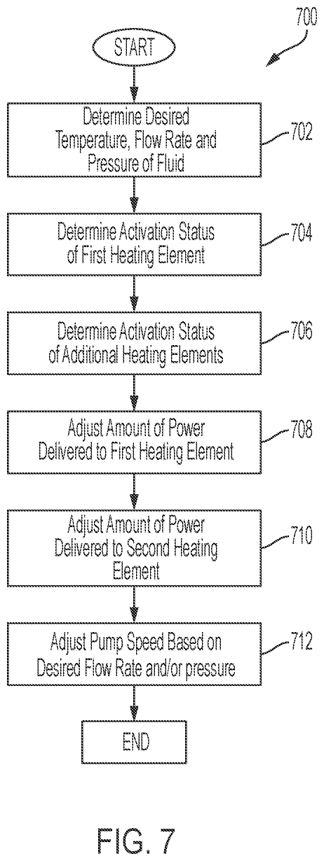

An electric fluid pumping system may employ electric heating elements to heat fluid pumped by the system. The use of electric heating elements may provide a greater amount of heat than provided by fluid pumping systems that heat fluid solely using heat recovered from equipment such as engines, allowing for greater flow rates. Furthermore, the use of electric heating elements may provide enhanced efficiency, cost effectiveness, and safety over systems where fired heat exchangers are implemented. A method 700 for heating fluid pumped by an electric fluid pumping system using one or more electrical resistance heating elements, shown in FIG. 7, may begin, at step 702, with determining a desired temperature, pressure, and flow rate of fluid pumped by the fluid pumping system. For example, a controller may receive an input specifying a desired temperature. Alternatively or additionally, a controller may receive an input specifying a fluid type and application and may determine a desired temperature and pressure based on the fluid type and application. The controller may also receive a desired flow rate of the fluid. For example, the electric fluid pumping system may pump and vaporize cryogenic fluids, such as nitrogen, at rates exceeding 500,000 standard cubic feet per hour (SCFH). The flow rate of the fluid may impact an amount of heat required to heat the fluid to a desired temperature, such as a temperature to vaporize a liquid and produce a desired vapor at a specific temperature and pressure.

At step 704, an activation status of a first electrical resistance heating element may be determined. For example, a controller may produce a demand for heat required to heat the fluid flowing at the desired flow rate to the desired temperature and may determine an activation status of the first heating element or bank of heating elements based on the amount of heat required. The determination of the activation status may include determining whether the first electrical resistance heating element or bank of electrical resistance heating elements should be energized or if a current flow to the electrical resistance heating element or bank of electrical resistance heating elements should be adjusted. For example, if less heat than a maximum heat capacity of the first electrical resistance heating element is required, adjusting an activation status of the first electrical resistance heating element may include adjusting a current flow to the first electrical resistance heating element to activate the first electrical resistance heating element at less than a full heat capacity. The determination of the activation status may include determining an amount of power and/or current that should be provided to the first electrical resistance heating element or bank of electrical resistance heating elements to generate the amount of heat required to heat the fluid to the desired temperature at the desired flow rate.

At step 706, an activation status of additional electrical resistance heating elements or banks, such as a second electrical resistance heating element or bank, may be determined, similarly to the determination of the activation status of the first electrical resistance heating element or bank. In some embodiments, a controller may determine whether one, or more, of the electrical resistance heating elements or banks of electrical resistance heating elements should be activated to provide the amount of heat required to heat the fluid to the desired temperature. For example, a controller may determine whether electrical resistance heating elements or banks of electrical resistance heating elements should be turned on or off and/or whether an amount of current supplied to one or more electrical resistance heating elements or banks of electrical resistance heating elements should be adjusted. In some embodiments, the first electrical heating element may be part of a first bank of electrical resistance heating elements, and the additional electrical resistance heating elements may be part of additional banks of electrical resistance heating elements. In such embodiments, a determination may be made of whether one, or more of the banks of electrical resistance heating elements should be activated. A controller may determine a most efficient activation configuration of electrical resistance heating elements and banks of electrical resistance heating elements to provide the amount of heat required to heat the fluid to the desired temperature and may determine activation statuses for each electrical resistance heating element or bank of electrical resistance heating elements based on the most efficient activation configuration. In some embodiments, the controller may determine the most efficient activation configuration based, at least in part, on a current load on the electric generator or the engine driving the generator.

At step 708, an amount of power delivered to the first heating element may be adjusted. For example, a controller may activate or deactivate the first electrical resistance heating element based on the determined activation status. In some embodiments, the controller may open or close a contactor, provide a demand for heat signal to an SCR, or provide a control signal to another controlled power output device to connect the first electrical resistance heating element to or disconnect the first electrical resistance heating element from a power source, such as an electric generator. In some embodiments the controller may increase or decrease an amount of power provided to the electrical resistance heating element without transitioning the element from an on state to an off state or from an off state to an on state in order to adjust an amount of heat provided by the electrical resistance heating element. At step 710, an amount of power provided to the additional electrical resistance heating elements, such as a second electrical resistance heating element may be adjusted. A controller may adjust the amount of power provided to the additional electrical resistance heating elements similarly to the adjustment of the amount of power provided to the first electrical resistance heating element. An adjustment to an amount of power provided to each of the first, second, and further electrical resistance heating elements may be performed by opening or closing separate contactors for each heating element, by adjusting the demand for heat signal value provided to a SCR, or by controlling another controlled power output device.

At step 712, a pump speed may be adjusted based on the desired flow rate and/or pressure. For example, a controller may control a pump drive speed based on a desired flow rate for the fluid pumped by the pump. Thus, a fluid pumped at a desired flow rate may be heated to a desired temperature. As one example, a cryogenic fluid, such as liquid nitrogen, stored in a reservoir for transportation on a vehicle may be pumped by an electrically driven pump at a desired flow rate. Based on the desired flow rate, one or more electrical resistance heating elements may be powered to heat the liquid, as it is pumped, to a desired temperature to vaporize the liquid and to raise the vapor to a desired vapor temperature and pressure. In some embodiments, a controller may include one or more variable frequency drives used to control a speed of an electric drive, such as an electric motor, driving the pump. Controlling the speed of the electric drive may, by extension, control a flow rate and pressure of fluid being pumped through the system.

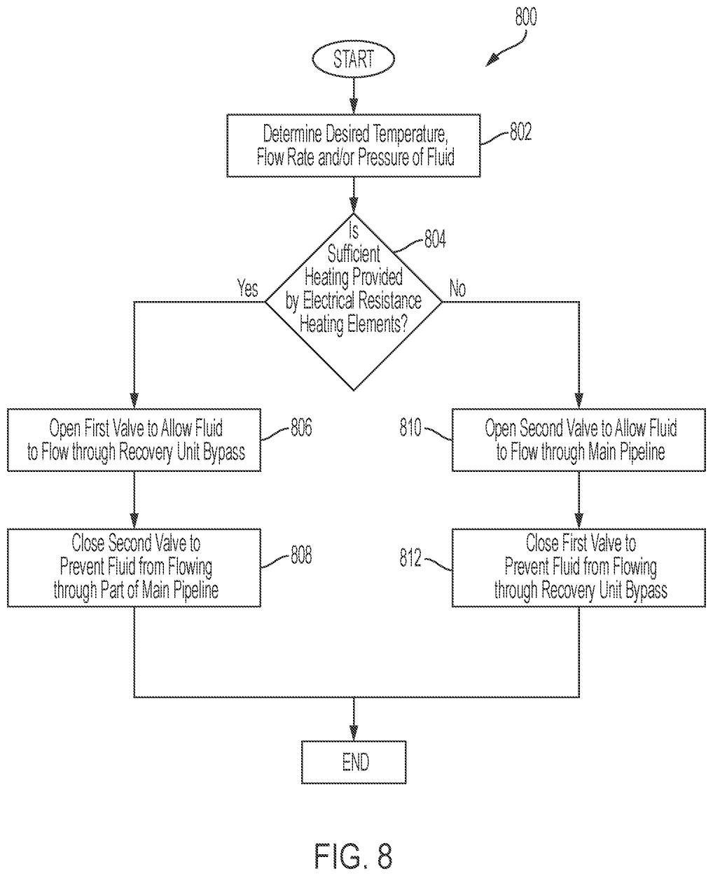

In some embodiments, additional heating methods may be used to accompany the electrical resistance heating elements to provide additional heating capabilities. For example, heat recovery units may be used to recover heat from equipment used in the pumping system, such as heat from a diesel engine, to heat the fluid. An example method 800, shown in FIG. 8, may begin, at step 802, with determining a desired temperature, pressure, and flow rate of the fluid. In some embodiments, method 800 may be performed following or contemporaneously with the method 700. The determination of the desired temperature, pressure, and flow rate of the fluid at step 802 may be the same determination made at step 702 of FIG. 7.

At step 804, a determination may be made of whether sufficient heating is provided by electrical resistance heating elements. For example, a controller may determine whether electrical resistance heating elements in the electric pumping system are able to provide sufficient heating to the fluid to raise a temperature of the fluid to a desired temperature level. In some embodiments, the controller may determine a most efficient combination of electrical resistance heating elements and heat recovery units, taking into account a load of the electric generator and engine, in determining an activation status of electrical resistance heating elements and whether the electrical resistance heating elements provide sufficient heating.

If the electrical resistance heating elements provide sufficient heating to the fluid to raise a temperature of the fluid to a desired level, a first valve may be opened, at step 808, to allow fluid to flow through a heat recovery unit bypass pipeline. For example, a portion of a main pipeline through which fluid is pumped by the electric fluid pumping system may be heated by one or more heat recovery units, such as radiant heat recovery units, charge air heat recovery units, engine oil heat recovery units, engine coolant heat recovery units, and exhaust heat recovery units. If sufficient heat is provided by the electrical resistance heating elements, heat from the heat recovery units may not be needed or desired. One or more bypass pipelines may be connected to the main pipeline to bypass portions of the main pipeline heated by the one or more heat recovery units. If a controller determines that heating from a heat recovery unit is not required to raise a temperature of the fluid to a desired temperature level, the controller may open a valve in the pipeline allowing fluid to flow through a bypass pipeline, bypassing a portion of the main pipeline heated by one or more heat recovery units. At step 808, a second valve in the main pipeline may be closed to prevent fluid from flowing through a portion of the main pipeline heated by one or more heat recovery units. In some embodiments, when multiple heat recovery units are present, multiple bypass pipelines may be included, and a controller may be configured to selectively bypass heat recovery units that are not needed to heat the fluid, while allowing the fluid to be heated by other heat recovery units.

If sufficient heating is not provided by the electrical resistance heating elements, a second valve may be opened, at step 810 to allow fluid pumped by the fluid pumping system to flow through a portion of the main pipeline heated by one or more heat recovery units. At step 812, a first valve for the bypass pipeline may be closed to prevent fluid from flowing through the heat recovery units bypass pipeline. Thus, when heating in addition to heating provided by one or more electrical resistance heating elements is required to raise a temperature of the fluid to a desired level, a controller may route fluid through a portion of a pipeline heated by one or more heat recovery units to provide additional heat to the fluid.

The flow chart diagrams of FIGS. 7-8 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. An apparatus, comprising:
an engine;
an electric generator coupled to and driven by the engine;
an electrically driven pump coupled to and powered by the electric generator; and
a first electrical resistance heating element coupled to and powered by the electric generator,
wherein the first electrical resistance heating element is positioned to heat fluid pumped by the electrically driven pump.

2. The apparatus of claim 1 further comprising:
a pipe coupled to an output of the electrically driven pump; and
a first heat exchanger coupled between the first electrical resistance heating element and at least a portion of the pipe,
wherein the electrically driven pump is configured to pump the fluid through the pipe, and
wherein the first heat exchanger is configured to transfer heat from the first electrical resistance heating element to the fluid in the pipe to heat the fluid.

3. The apparatus of claim 2, further comprising:
a heat recovery unit, wherein the heat recovery unit is configured to transfer heat generated by the engine to the fluid pumped by the electrically driven pump.

4. The apparatus of claim 3, wherein the heat recovery unit comprises at least one of:
an engine coolant heat recovery unit;
a radiant heat recovery unit;
a charge air heat recovery unit;
an engine oil heat recovery unit; and
an engine exhaust heat recovery unit.

5. The apparatus of claim 3, wherein:
the heat recovery unit comprises a second heat exchanger coupled to the pipe,
wherein the first heat exchanger is coupled to the pipe closer to the electrically driven pump than the second heat exchanger, such that the fluid is heated by the first heat exchanger before it is heated by the second heat exchanger.

6. The apparatus of claim 5, further comprising a bypass pipeline for bypassing, by the fluid, a portion of the pipe to which the second heat exchanger is coupled.

7. The apparatus of claim 6, further comprising a controller, wherein the controller is configured to route the fluid through the bypass pipeline or close off the bypass pipeline based, at least in part, on a desired temperature of the fluid.

8. The apparatus of claim 1, further comprising:
a first bank of electrical resistance heating elements, wherein the first bank of electrical resistance heating elements comprises the first electrical resistance heating element;
one or more additional banks of electrical resistance heating elements; and
a controller,
wherein the controller is configured to selectively energize the first and one or more additional banks of electrical resistance heating elements to vary an electric load on the electric generator and to provide variable heating to the fluid.

9. The apparatus of claim 8, wherein the controller is further configured to control a flow rate, pressure, and temperature of the fluid by selectively energizing the first and one or more additional banks and controlling a speed of the electrically driven pump and thus a load on the generator.

10. A method for heating fluid comprising:
generating power using an electric generator driven by an engine to power an electrically driven pump;
pumping fluid through a piping system using the electrically driven pump powered by the electric generator; and
heating the fluid as it is pumped through the piping system using a first electrical resistance heating element.

11. The method of claim 10, further comprising heating the fluid as it is pumped through the piping system, after the fluid is heated using the first electrical resistance heating element, using a heat recovery unit, wherein the heat recovery unit is configured to transfer heat generated by the engine to the fluid pumped by the electrically driven pump.

12. The method of claim 11, further comprising controlling, by a controller, a flow of the fluid to bypass at least one of the first electrical resistance heating element and the heat recovery unit based on a desired fluid temperature.

13. The method of claim 10, further comprising:
heating the fluid as it is pumped through the piping system using one or more additional electrical resistance heating elements.

14. The method of claim 13, further comprising deactivating, by a controller, at least one of the first electrical resistance heating element and the one or more additional electrical resistance heating elements based on a desired fluid temperature.

15. An apparatus comprising
an electric generator;
a fluid piping system;
an electrically driven pump coupled to and powered by the electric generator and coupled to the piping system to pump fluid through the fluid piping system;
a first electrical resistance heating element coupled to and powered by the electric generator and positioned to heat the fluid pumped through the piping system by the electrically driven pump; and
a controller,
wherein the controller is configured to perform steps comprising:
determining an activation status of the first electrical resistance heating element based, at least in part, on a desired fluid temperature; and
adjusting an amount of power provided to the first electrical resistance heating element based, at least in part, on the determined activation status of the first electrical resistance heating element.

16. The apparatus of claim 15, further comprising:
one or more additional electrical resistance heating elements coupled to and powered by the electric generator and positioned to heat the fluid pumped through the piping system by the electrically driven pump,
wherein the controller is further configured to perform steps comprising:
determining an activation status of the one or more additional electrical resistance heating elements based, at least in part, on the desired fluid temperature; and
adjusting an amount of power provided to the one or more additional electrical resistance heating elements based, at least in part, on the determined activation status of the one or more additional electrical resistance heating elements.

17. The apparatus of claim 15, wherein the controller is further configured to determine the activation status of the first and one or more additional electrical resistance heating elements further based on a flow rate of the fluid.

18. The apparatus of claim 15, wherein the controller is further configured to perform steps comprising: controlling a speed of the electrically driven pump to achieve a desired flow rate or pressure of the fluid through the fluid piping system.

19. The apparatus of claim 15, further comprising:
a heat recovery unit, wherein the heat recovery unit is configured to transfer heat generated by an engine driving the electric generator to the fluid pumped by the electrically driven pump,
wherein the fluid piping system comprises a bypass pipeline for bypassing a portion of the fluid piping system heated by the heat recovery unit, and
wherein the controller is further configured to perform steps comprising: diverting the fluid to flow through the bypass pipeline based, at least in part, on a desired fluid temperature.

20. The apparatus of claim 19, wherein diverting the fluid to flow through the bypass pipeline comprises opening a first valve of the bypass pipeline to allow fluid to flow through the bypass pipeline and closing a second valve of the fluid piping system to prevent fluid from flowing through a portion of the fluid piping system heated by the heat recovery unit.
